(19) United States
(12) Patent Application Publication
(10) Pub. No.: US 2011/0311730 A1
(43) Pub. Date: Dec. 22, 2011

(54) Sealant Application Tool

(75) Inventors: Solomon T. Atsebha, Seattle, WA (US); Mark Douglas Fuller, Snohomish, WA (US)

(73) Assignee: THE BOEING COMPANY, Chicago, IL (US)

(21) Appl. No.: 12/818,350

(22) Filed: Jun. 18, 2010

(51) Int. Cl. B05D 1/02; B65D 25/40

(52) U.S. Cl. 427/421.1; 222/566

(57) ABSTRACT

A method and apparatus for applying a sealant. A sealant application system is positioned over a fastener. The sealant application system comprises an elongate member, a first channel, a nozzle, a second channel, and a biasing system. The elongate member has a first end connected to a sealant source for the sealant and a second end. The first channel extends through the elongate member from the first end to the second end. The nozzle has an input associated with the first end of the elongate member and an output. The second channel extends through the nozzle from the input to the output. The first channel is in communication with the second channel. The biasing system is configured to engage an outer surface of the nozzle and move on the outer surface of the nozzle such that the second channel changes shape. The sealant is applied onto the fastener.

### BACKGROUND INFORMATION

1. Field

The present disclosure relates generally to tool systems and, in particular, to tools used to apply sealants. Still more particularly, the present disclosure relates to a method and apparatus to control sealant placed onto a fastener.

2. Background

In manufacturing aircraft, different parts are assembled to form structures or substructures for the aircraft. The assembly of parts may be performed in a number of different ways. For example, parts may be bonded to each other using processes, such as soldering, taping, gluing, cementing, and/or other suitable types of processes. Additionally, parts also may be connected to each other mechanically.

With mechanical fastening of parts to each other, fasteners are used to join two or more parts to each other. Fasteners may take a number of different forms. For example, fasteners may be bolts, screws, rivets, and/or other suitable types of fasteners. With the use of fasteners, a hole is formed through the different parts to be joined to each other. The fastener is then placed through the hole and secured to connect the parts to each other.

In some cases, the use of fasteners may occur in locations in which a liquid or air is contained within or surrounds a structure or substructure. For example, with a fuel tank, the use of fasteners to connect parts to each other to form the fuel tank may allow fuel or air to exit the fuel tank or other liquids to enter the fuel tank. The movement of liquids or gases may occur in locations where the fasteners are present. As a result, these locations may need to be sealed to prevent movement of these liquids or gases in these locations. The sealing of these locations may be performed using a sealant. For example, a sealant may be applied over a fastener in the location where the fastener is exposed on the surface of a structure.

Oftentimes, specifications or requirements may be present as to how the sealant is applied. For example, without limitation, the height, width, and/or other dimensions of the sealant placed onto a fastener may be specified. To meet these requirements, the sealant may be measured after application of the sealant on the fastener. If an inadequate amount of sealant is present with respect to one or more dimensions, the sealant may be shaped to meet the dimensions. In some cases, additional sealant may be added and/or other operations may be performed to meet the requirements for sealant on the fastener.

This type of process may be time consuming and may increase the cost in manufacturing aircraft. For example, a number of operators may be needed for this type of process. In some cases, one operator applies the sealant and another operator inspects the sealant and makes needed changes.

Therefore, it would be advantageous to have a method and apparatus that takes into account at least some of the issues discussed above, as well as other possible issues.

### SUMMARY

In one advantageous embodiment, an apparatus comprises an elongate member, a first channel, a nozzle, a second channel, and a biasing system. The elongate member has a first end and a second end. The first channel extends through the elongate member from the first end of the elongate member to the second end of the elongate member. The nozzle has an input and an output. The input of the nozzle is associated with the first end of the elongate member. The second channel extends through the nozzle from the input of the nozzle to the output of the nozzle. The first channel is in communication with the second channel. The biasing system is configured to engage an outer surface of the nozzle. The biasing system is configured to move on the outer surface of the nozzle such that the second channel changes shape.

In another advantageous embodiment, a sealant application system for applying a sealant comprises a first elongate member, a nozzle, a second elongate member, and a positioning system. The first elongate member has a first end, a second end, and a first channel extending through the first elongate member from the first end of the first elongate member to the second end of the first elongate member. The nozzle has an input associated with the first end of the first elongate member, an output, and a second channel extending through the nozzle from the input of the nozzle to the output of the nozzle. The first channel is in communication with the second channel. The second elongate member has a first end, a second end, and a third channel extending through the second elongate member from the first end of the second elongate member to the second end of the second elongate member. The third channel is configured to receive at least a portion of the first elongate member and at least a portion of the nozzle. The first end of the second elongate member is configured to engage an outer surface of the nozzle. The positioning system is configured to guide movement of the second elongate member on the outer surface of the nozzle relative to the first elongate member along an axis through the nozzle. The movement of the second elongate member on the outer surface of the nozzle causes the second channel to change shape.

In yet another advantageous embodiment, a method is provided for applying a sealant. A sealant application system is positioned over a fastener. The sealant application system comprises an elongate member having a first end and a second end. The first end is connected to a sealant source for the sealant. The first channel extends through the elongate member from the first end of the elongate member to the second end of the elongate member. A nozzle has an input and an output. The input of the nozzle is associated with the first end of the elongate member. A second channel extends through the nozzle from the input of the nozzle to the output of the nozzle. The first channel is in communication with the second channel. A biasing system is configured to engage an outer surface of the nozzle. The biasing system is configured to move on the outer surface of the nozzle such that the second channel changes shape. The sealant is applied onto the fastener.

The features, functions, and advantages can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the advantageous embodiments are set forth in the appended claims. The advantageous embodiments, however, as well as a preferred mode of use, further objectives, and advantages thereof, will best be understood by reference to the following detailed description of an advantageous embodiment of the present disclosure when read in conjunction with the accompanying drawings, wherein:

FIG. 1 is an illustration of an aircraft manufacturing and service method in accordance with an advantageous embodiment;

FIG. 2 is an illustration of an aircraft in which an advantageous embodiment may be implemented;

FIG. 3 is an illustration of a sealant environment in accordance with an advantageous embodiment;

FIG. 4 is an illustration of an applicator tool in accordance with an advantageous embodiment;

FIG. 5 is an illustration of a sealant application system in accordance with an advantageous embodiment;

FIG. 6 is an illustration of an exploded perspective view of a portion of a sealant application system in accordance with an advantageous embodiment;

FIG. 7 is an illustration of a perspective view of a portion of a sealant application system in accordance with an advantageous embodiment;

FIG. 8 is an illustration of a perspective view of a portion of a sealant application system in accordance with an advantageous embodiment;

FIG. 9 is an illustration of an exposed view of a portion of a sealant application system in accordance with an advantageous embodiment;

FIG. 10 is an illustration of an end view of a portion of a sealant application system in accordance with an advantageous embodiment;

FIG. 11 is an illustration of an exposed view of a portion of a sealant application system in accordance with an advantageous embodiment;

FIG. 12 is an illustration of an end view of a portion of a sealant application system in accordance with an advantageous embodiment;

FIG. 13 is an illustration of an exposed view of a portion of a sealant application system in accordance with an advantageous embodiment;

FIG. 14 is an illustration of an exposed view of a portion of a sealant application system in accordance with an advantageous embodiment;

FIG. 15 is an illustration of an end view of a portion of a sealant application system in accordance with an advantageous embodiment;

FIG. 16 is an illustration of an exposed view of a portion of a sealant application system in accordance with an advantageous embodiment;

FIG. 17 is an illustration of an applicator tool in accordance with an advantageous embodiment;

FIG. 18 is an illustration of a perspective view of an applicator tool in accordance with an advantageous embodiment;

FIG. 19 is an illustration of a cross-sectional perspective view of an applicator tool over a fastener in accordance with an advantageous embodiment; and

FIG. 20 is an illustration of a flowchart of a process for applying sealant in accordance with an advantageous embodiment.

### DETAILED DESCRIPTION

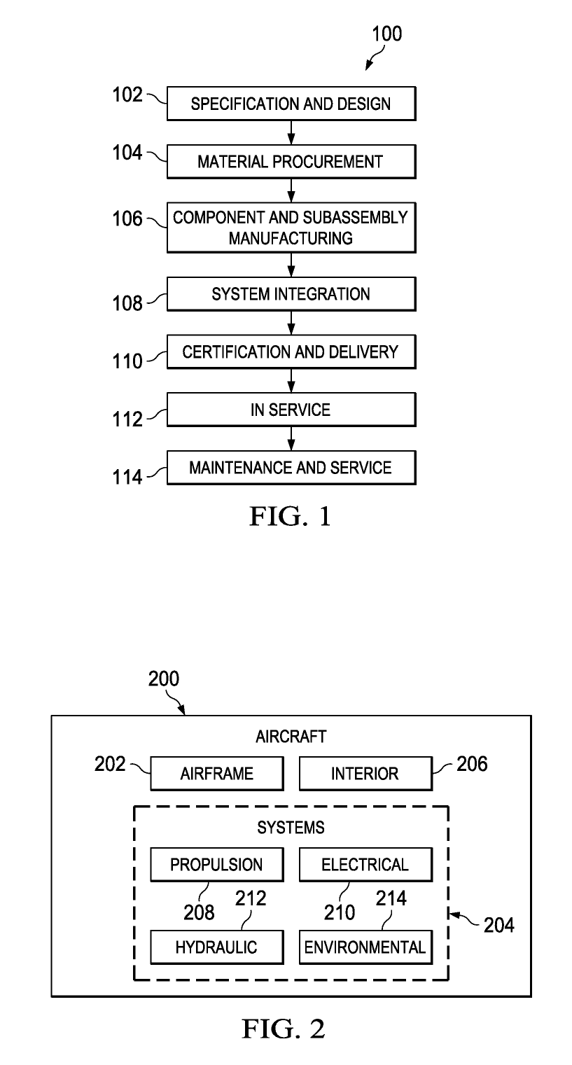

Referring more particularly to the drawings, embodiments of the disclosure may be described in the context of aircraft manufacturing and service method 100 as shown in FIG. 1 and aircraft 200 as shown in FIG. 2. Turning first to FIG. 1, an illustration of an aircraft manufacturing and service method is depicted in accordance with an advantageous embodiment. During pre-production, aircraft manufacturing and service method 100 may include specification and design 102 of aircraft 200 in FIG. 2 and material procurement 104.

During production, component and subassembly manufacturing 106 and system integration 108 of aircraft 200 in FIG. 2 takes place. Thereafter, aircraft 200 in FIG. 2 may go through certification and delivery 110 in order to be placed in service 112. While in service 112 by a customer, aircraft 200 in FIG. 2 is scheduled for routine maintenance and service 114, which may include modification, reconfiguration, refurbishment, and other maintenance or service.

Each of the processes of aircraft manufacturing and service method 100 may be performed or carried out by a system integrator, a third party, and/or an operator. In these examples, the operator may be a customer. For the purposes of this description, a system integrator may include, without limitation, any number of aircraft manufacturers and major-system subcontractors; a third party may include, without limitation, any number of venders, subcontractors, and suppliers; and an operator may be an airline, leasing company, military entity, service organization, and so on.

With reference now to FIG. 2, an illustration of an aircraft is depicted in which an advantageous embodiment may be implemented. In this example, aircraft 200 is produced by aircraft manufacturing and service method 100 in FIG. 1 and may include airframe 202 with a plurality of systems 204 and interior 206. Examples of systems 204 include one or more of propulsion system 208, electrical system 210, hydraulic system 212, and environmental system 214. Any number of other systems may be included. Although an aerospace example is shown, different advantageous embodiments may be applied to other industries, such as the automotive industry.

Apparatus and methods embodied herein may be employed during at least one of the stages of aircraft manufacturing and service method 100 in FIG. 1. As used herein, the phrase “at least one of”, when used with a list of items, means that different combinations of one or more of the listed items may be used and only one of each item in the list may be needed. For example, “at least one of item A, item B, and item C” may include, for example, without limitation, item A or item A and item B. This example also may include item A, item B, and item C or item B and item C.

In one illustrative example, components or subassemblies produced in component and subassembly manufacturing 106 in FIG. 1 may be fabricated or manufactured in a manner similar to components or subassemblies produced while aircraft 200 is in service 112 in FIG. 1. As yet another example, a number of apparatus embodiments, method embodiments, or a combination thereof may be utilized during production stages, such as component and subassembly manufacturing 106 and system integration 108 in FIG. 1. A number, when referring to items, means one or more items. For example, a number of apparatus embodiments may be one or more apparatus embodiments. A number of apparatus embodiments, method embodiments, or a combination thereof may be utilized while aircraft 200 is in service 112 and/or during maintenance and service 114 in FIG. 1. The use of a number of the different advantageous embodiments may substantially expedite the assembly of and/or reduce the cost of aircraft 200.

The different advantageous embodiments recognize and take into account a number of different considerations. For example, the different advantageous embodiments recognize and take into account that applying a sealant onto fasteners with the desired dimensions and/or in the desired amount may be time consuming.

The different advantageous embodiments recognize and take into account that one manner in which sealants may be applied onto fasteners is with the use of a tool to apply the sealant with the desired dimensions for the shape of the sealant. This type of process may be more time consuming than desired.

The different advantageous embodiments also recognize and take into account that sealant may be applied using a nozzle that has a shape with the desired dimensions for the sealant. The different advantageous embodiments recognize and take into account, however, that with different locations for fasteners, different requirements may be present for applying the sealant. Additionally, when the type or size of the fasteners change, the requirements for placement of sealant also may be different.

As a result, the different advantageous embodiments recognize and take into account that different nozzles may be used for different locations. These nozzles may have predefined sizes and/or shapes.

For example, when requirements change, a nozzle may be replaced with another nozzle having a different size and/or shape.

Additionally, pre-sized cups may be placed on the tip of a nozzle for use at the different locations. These pre-sized cups may be disposable. These pre-sized cups are also referred to as daubing cups. For example, when the requirements for the placement of sealant change, one daubing cup may be removed from the nozzle and replaced with a daubing cup having a different size and/or shape.

The different advantageous embodiments recognize and take into account, however, that with multiple nozzles and/or with multiple daubing cups having different sizes, replacing these nozzles and/or daubing cups may take additional time. Further, in some cases, a limited number of nozzles and/or daubing cups may be present, misplaced, and/or lost. As a result, the different advantageous embodiments recognize and take into account that using different nozzles and/or daubing cups for different fastener requirements may require more time or cost than desired.

Thus, the different advantageous embodiments provide a method and apparatus for applying a sealant to a structure. In one advantageous embodiment, an apparatus comprises an elongate member having a first end and a second end. A channel extends through the elongate member in the first end to the second end. A nozzle is present having an input and an output. The input of the nozzle is associated with the first end of the elongate member. A second channel extends through the nozzle from the input of the nozzle to the output of the nozzle. The first channel is in communication with the second channel. The apparatus also includes a biasing system. The biasing system is configured to engage an outer surface of the nozzle. The biasing system is configured to move on the outer surface of the nozzle such that the shape of the second channel changes.

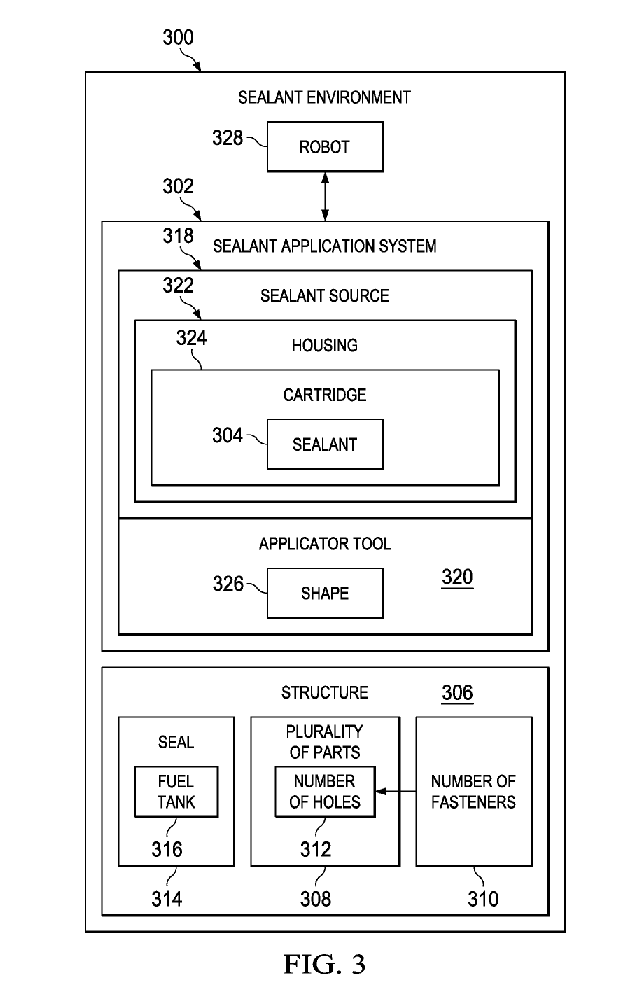

With reference now to FIG. 3, an illustration of a sealant environment is depicted in accordance with an advantageous embodiment. Sealant environment 300 is an example of an environment that may be present and used in one or more phases of aircraft manufacturing and service method 100 in FIG. 1. Sealant environment 300 may be used to assemble, rework, prepare, and/or perform other operations on structures in aircraft 200 in FIG. 2.

As illustrated, sealant application system 302 is used to apply sealant 304 to structure 306 in sealant environment 300. In these illustrative examples, structure 306 is a structure, such as aircraft 200, a subassembly in aircraft 200, a component in aircraft 200 in FIG. 2, or some other suitable type of structure. Structure 306 is comprised of plurality of parts 308.

Number of fasteners 310 connects to plurality of parts 308. A fastener within number of fasteners 310 is a device that mechanically connects two or more parts within plurality of parts 308 together. In these illustrative examples, number of fasteners 310 may take a number of different forms. For example, without limitation, number of fasteners 310 may be at least one of a bolt, a rivet, a screw, and other suitable types of devices. In these illustrative examples, number of fasteners 310 is placed within number of holes 312 extending through plurality of parts 308 to fasten plurality of parts 308 to each other.

When number of fasteners 310 is placed within number of holes 312, sealant 304 may be applied to number of fasteners 310. The application of sealant 304 to number of fasteners 310 may be applied for a number of different reasons.

For example, sealant 304 may be used to form seal 314 for structure 306. As one specific example, structure 306 may take the form of fuel tank 316. Seal 314 is used to prevent moisture, liquids, and gases from moving into or out of fuel tank 316 where number of fasteners 310 is located. In yet other illustrative examples, sealant 304 may be used to cover or protect number of fasteners 310.

As depicted, sealant application system 302 comprises sealant source 318 and applicator tool 320. Sealant source 318, in this illustrative example, includes housing 322 and cartridge 324. Cartridge 324 holds sealant 304.

In these illustrative examples, applicator tool 320 is associated with sealant source 318. A first component may considered to be associated with a second component by being secured to the second component, bonded to the second component, fastened to the second component, and/or connected to the second component in some other suitable manner. The first component also may be connected to the second component by using a third component. The first component may also be considered to be associated with the second component by being formed as part of and/or an extension of the second component.

In these illustrative examples, applicator tool 320 has shape 326. Shape 326 may be changed. Changing shape 326 of applicator tool 320 provides a capability to change the manner in which sealant 304 is applied to number of fasteners 310.

In these advantageous embodiments, shape 326 may be changed such that characteristics for applying sealant 304 may be changed. These characteristics include, for example, the amount of sealant 304 applied, the dimensions for sealant 304, and/or other suitable characteristics. The change in shape 326 is formed without requiring a replacement of applicator tool 320 with another tool.

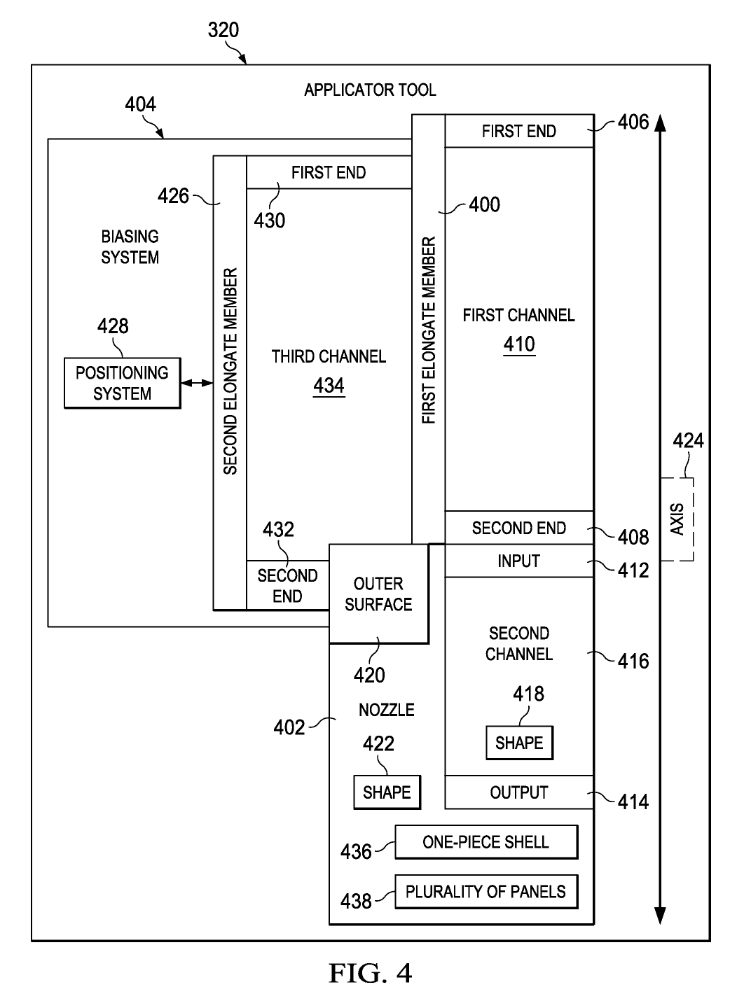

With reference now to FIG. 4, an illustration of an applicator tool is depicted in accordance with an advantageous embodiment. In this illustrative example, different features that may be present in applicator tool 320 in FIG. 3 are illustrated.

Applicator tool 320, in this illustrative example, comprises first elongate member 400, nozzle 402, and biasing system 404. First elongate member 400 has first end 406 and second end 408. First channel 410 extends through first elongate member 400 from first end 406 to second end 408.

In the illustrative example, second end 408 of first elongate member 400 is configured to be connected to cartridge 324 in sealant source 318 in FIG. 3. Nozzle 402 is a structure configured to allow sealant 304 to flow from sealant source 318 to a fastener in number of fasteners 310 in FIG. 3. Nozzle 402 has input 412 and output 414. Input 412 of nozzle 402 is associated with first end 406 of first elongate member 400. Second channel 416 extends through nozzle 402 from input 412 to output 414. Further, second channel 416 has shape 418.

Biasing system 404 is configured to engage outer surface 420 of nozzle 402. Biasing system 404 is configured to move on outer surface 420 such that shape 418 of second channel 416 changes in response to movement of biasing system 404 on outer surface 420. In particular, movement of biasing system 404 on outer surface 420 changes shape 422 of nozzle 402, which in turn changes shape 418 of second channel 416 in nozzle 402. In these illustrative examples, axis 424 extends through first channel 410 and second channel 416.

In these illustrative examples, first channel 410 and second channel 416 are coaxial to each other. In other words, axis 424 is a common axis for first channel 410 and second channel 416 in these examples.

In these illustrative examples, biasing system 404 comprises second elongate member 426 and positioning system 428. Second elongate member 426 has first end 430 and second end 432. Third channel 434 extends from first end 430 to second end 432 in these examples. Third channel 434 is configured to receive at least a portion of first elongate member 400 and at least a portion of nozzle 402. Movement of first end 430 of second elongate member 426 on outer surface 420 of nozzle 402 along axis 424 causes shape 422 of nozzle 402 to change. This change in shape 422 also causes shape 418 of second channel 416 in nozzle 402 to change.

In this manner, shape 418 may be changed to apply different amounts of sealant 304 onto number of fasteners 310 in FIG. 3. Different amounts of sealant 304 may be applied onto number of fasteners 310 in FIG. 3, depending on the desired amounts of sealant for each fastener. Further, by changing shape 418 of second channel 416, the dimensions of sealant 304 applied to number of fasteners 310 in FIG. 3 may be changed to desired dimensions. The desired amount of sealant may change, depending on the purpose of the sealant, the size of the fastener, the location of the fastener in structure 306 in FIG. 3, and other suitable factors.

Positioning system 428 is used to hold second elongate member 426 in a desired position, move second elongate member 426, or a combination of holding and moving second elongate member 426.

In these illustrative examples, nozzle 402 may be, for example, without limitation, one piece shell 436, plurality of panels 438, and/or some other suitable type of structure that allows for shape 418 of second channel 416 to be changed by biasing system 404.

The different components in applicator tool 320 in FIG. 4 may be comprised of the same types of material or different materials. For example, first elongate member 400, nozzle 402, and second elongate member 426 may all be manufactured from the same types of material or from different types of materials. The type of materials that may be used for the different components may be selected from at least one of nylon, polyethylene, polyurethane, partly polypropylene, metal, polytetrafluoroethylene, and/or other suitable materials. In these illustrative examples, nozzle 402 may be made of any material that is suitable for use with sealant 304 in FIG. 3 and is capable of changing shape 418.

In this manner, when the amount of sealant needs to change, biasing system 404 may be operated to change shape 418 of second channel 416 to provide the appropriate amount, shape, dimensions, or other characteristics for sealant 304 on the particular fastener in number of fasteners 310 in FIG. 3. As the characteristics desired for the application of sealant 304 change, biasing system 404 may change shape 418 of second channel 416.

This change in shape 418 of second channel 416 may be performed instead of replacing nozzles with a nozzle having a predefined shape. Additionally, the use of applicator tool 320 in the illustrative examples may reduce or avoid the need for an operator to use a tool to change the shape or dimensions of sealant 304 on number of fasteners 310 after sealant 304 has been placed onto number of fasteners 310 in FIG. 3.

In these illustrative examples, nozzle 402 may be cleaned after use and reused. For example, nozzle 402 may be used multiple times for applying sealant to different locations.

In this manner, the amount of time and cost for performing operations in structure 306 in FIG. 3 may be reduced. These operations, in these examples, may be performed at different times. For example, these operations may be performed during the manufacturing of structure 306, maintenance of structure 306, and other suitable operations.

The illustrations of sealant environment 300 in FIG. 3 and applicator tool 320 in FIG. 4 are not meant to imply physical or architectural limitations to the manner in which different advantageous embodiments may be implemented. Other components in addition to and/or in place of the ones illustrated may be used. Some components may be unnecessary in some advantageous embodiments. Also, the blocks are presented to illustrate some functional components. One or more of these blocks may be combined and/or divided into different blocks when implemented in different advantageous embodiments.

For example, in some illustrative examples, sealant application system 302 also may include robot 328, which may be the operator for applying sealant 304 onto structure 306. With this type of implementation, applicator tool 320 may be an end effector for robot 328. In yet other illustrative examples, housing 322 may include a tank or reservoir to hold sealant 304. With this type of implementation, sealant source 318 does not need cartridge 324.

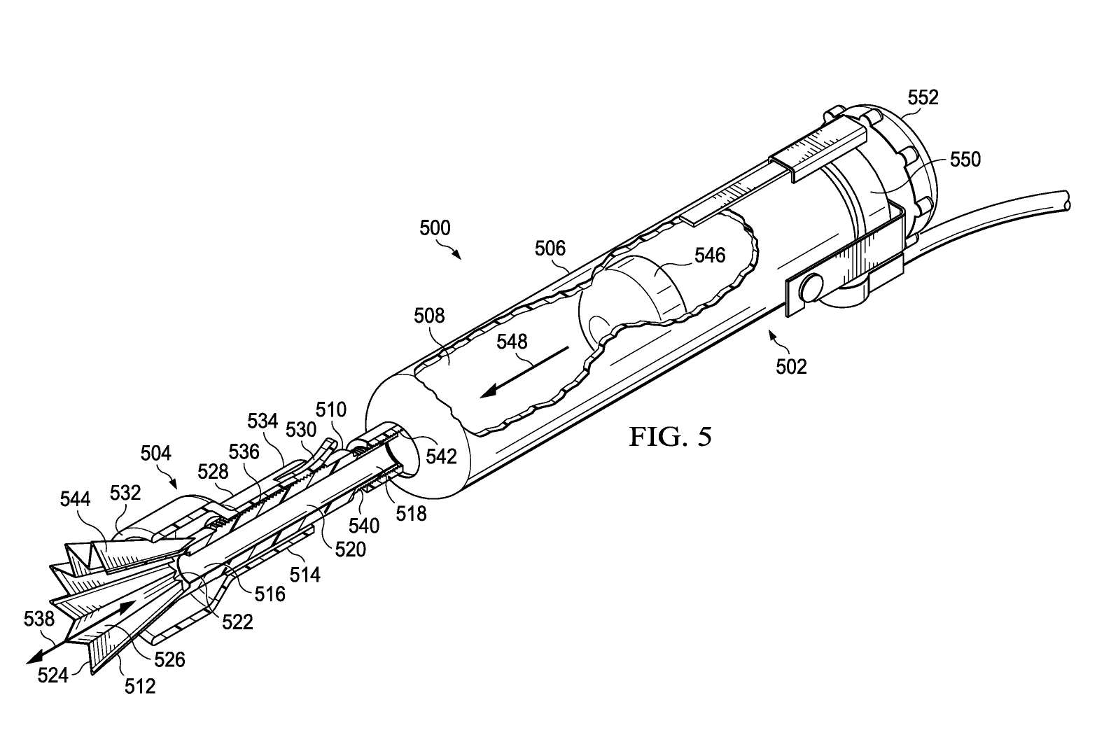

With reference now to FIG. 5, an illustration of a sealant application system is depicted in accordance with an advantageous embodiment. Sealant application system 500 is an example of one implementation of sealant application system 302 in FIG. 3. In this example, sealant application system 500 is shown in a perspective view. The view is an exposed view to provide a view of the different components within sealant application system 500 in the assembled form.

Sealant application system 500 comprises sealant source 502 and applicator tool 504. Sealant source 502 includes housing 506 and cartridge 508. As can be seen in this illustrative example, cartridge 508 is located within housing 506. Further, sealant is located within cartridge 508 in these illustrative examples.

Applicator tool 504 comprises first elongate member 510, nozzle 512, and biasing system 514. First elongate member 510 has first end 516 and second end 518. First channel 520 extends through first elongate member 510 from first end 516 to second end 518.

As depicted, second end 518 of first elongate member 510 is associated with cartridge 508 in sealant source 502. In these examples, threads 540 at second end 518 of first elongate member 510 may engage threads 542 in cartridge 508.

Nozzle 512 has input 522 and output 524. Input 522 is associated with first end 516 of first elongate member 510. In this example, input 522 of nozzle 512 may be formed as part of elongate member 510 at first end 516. In other illustrative examples, input 522 may be secured or connected to first end 516. Nozzle 512 has second channel 526. Second channel 526 extends through nozzle 512 from input 522 to output 524.

In this depicted example, biasing system 514 comprises second elongate member 528 and positioning system 530. Second elongate member 528 has first end 532 and second end 534. Third channel 536 extends through second elongate member 528 from first end 532 to second end 534. As seen in this illustrative example, axis 538 extends through first channel 520, second channel 526, and third channel 536. These channels are coaxial with each other in these illustrative examples.

At least a portion of first elongate member 510 and at least a portion of nozzle 512 may be received within third channel 536 of second elongate member 528. First channel 520 in first elongate member 510 and second channel 526 in nozzle 512 may receive sealant from cartridge 508 in these examples. Sealant may be output at output 524 of nozzle 512 in these examples.

The shape of nozzle 512 in second channel 526 may be changed using biasing system 514. For example, first end 532 of second elongate member 528 is configured to engage outer surface 544 of nozzle 512 in these illustrative examples. As second elongate member 528 and biasing system 514 are moved along axis 538, first end 532 engages outer surface 544 such that the shape of nozzle 512 changes. Changing the shape of nozzle 512 also changes the shape of second channel 526.

Although, in these illustrative examples, first end 532 of second elongate member 528 engages outer surface 544 to change the shape of nozzle 512, other mechanisms may be used to change the shape of nozzle 512. For example, second elongate member 528 may have flanges or other members located within third channel 536 that engage outer surface 544 of nozzle 512. As a result, these flanges or members may change the shape of nozzle 512 rather than first end 532.

Positioning system 530, in these illustrative examples, holds second elongate member 528 in a position. In other words, positioning system 530 may prevent second elongate member 528 from moving while sealant is being applied to a fastener. Additionally, positioning system 530 may be operated to allow a change in the position of second elongate member 528 relative to first elongate member 510 and/or nozzle 512.

In these illustrative examples, effector 546 may be moved in the direction of arrow 548 to cause sealant to be moved from cartridge 508 through first channel 520 and second channel 526 to output 524 of nozzle 512. The movement of effector 546 may be performed using motor 550 in these examples. In other illustrative examples, effector 546 may be moved through the manipulation of knob 552 by an operator.

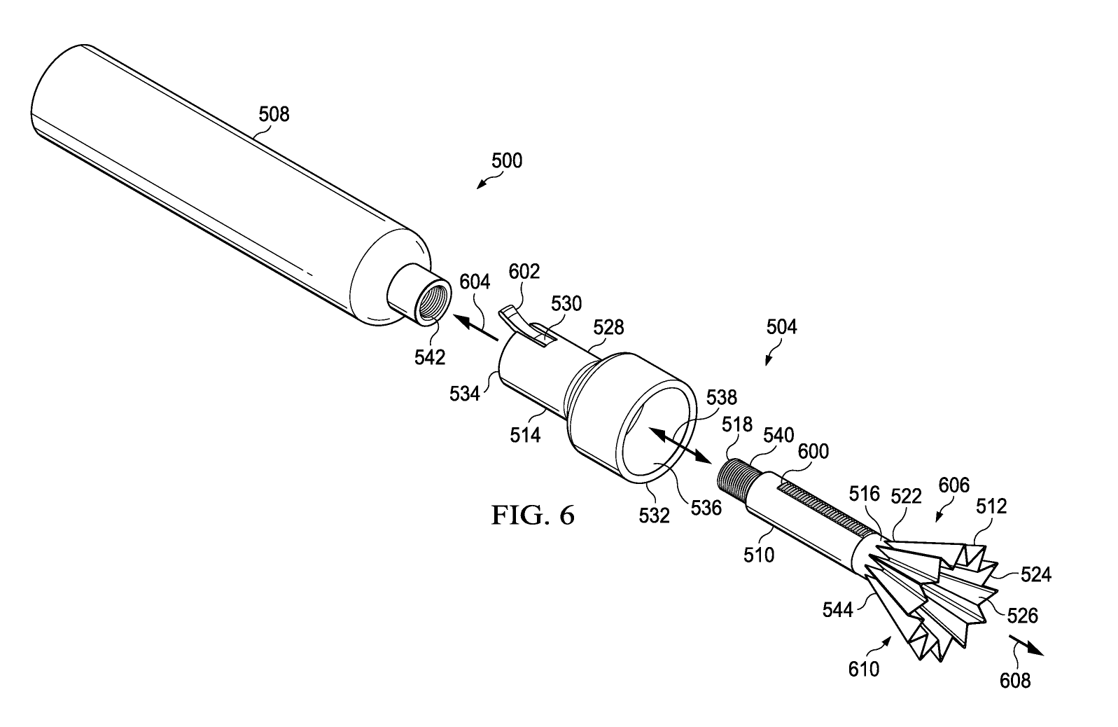

With reference now to FIG. 6, an illustration of an exploded perspective view of a portion of a sealant application system is depicted in accordance with an advantageous embodiment. In this illustrative example, cartridge 508, first elongate member 510, and second elongate member 528 for sealant application system 500 are depicted. Housing 506 for sealant source 502, effector 546, motor 550, and knob 552 are not shown for purposes of illustrating cartridge 508, first elongate member 510, and second elongate member 528 more clearly.

As depicted, first elongate member 510 has teeth 600. Teeth 600 form a ratchet. Teeth 600 engage teeth (not shown in this view) inside second elongate member 528. The teeth inside second elongate member 528 form a pawl. Positioning system 530 is configured to hold second elongate member 528 in a position when teeth 600 engage the teeth inside second elongate member 528. When teeth 600 are engaged with the teeth inside second elongate member 528, second elongate member 528 is not allowed to rotate about axis 538.

In this illustrative example, positioning system 530 has lever 602. As depicted, lever 602 is used to operate positioning system 530 to allow a change in the position of second elongate member 528 and/or nozzle 512.

For example, lever 602 may be moved in the direction of arrow 604 to disengage the teeth inside second elongate member 528 from teeth 600 on first elongate member 510. When teeth 600 are disengaged from the teeth inside second elongate member 528, second elongate member 528 may be moved along axis 538 to change the position of second elongate member 528.

In this illustrative example, second elongate member 528 may be moved along axis 538 to change the position of second elongate member 528 to change shape 606 of nozzle 512. Shape 606 of nozzle 512 may be changed to change the amount of, dimensions for, and/or other characteristics for the sealant applied through nozzle 512.

Once second elongate member 528 has been moved to the desired position, a sufficient force is needed to move second elongate member 528 in the direction of arrow 608. Further, only movement of lever 602 may allow movement of second elongate member 528 in the direction of arrow 608.

In this illustrative example, nozzle 512 takes the form of one-piece shell 610. One-piece shell 610 has flexibility that allows the shape of one-piece shell 610 to change shape 606 for nozzle 512.

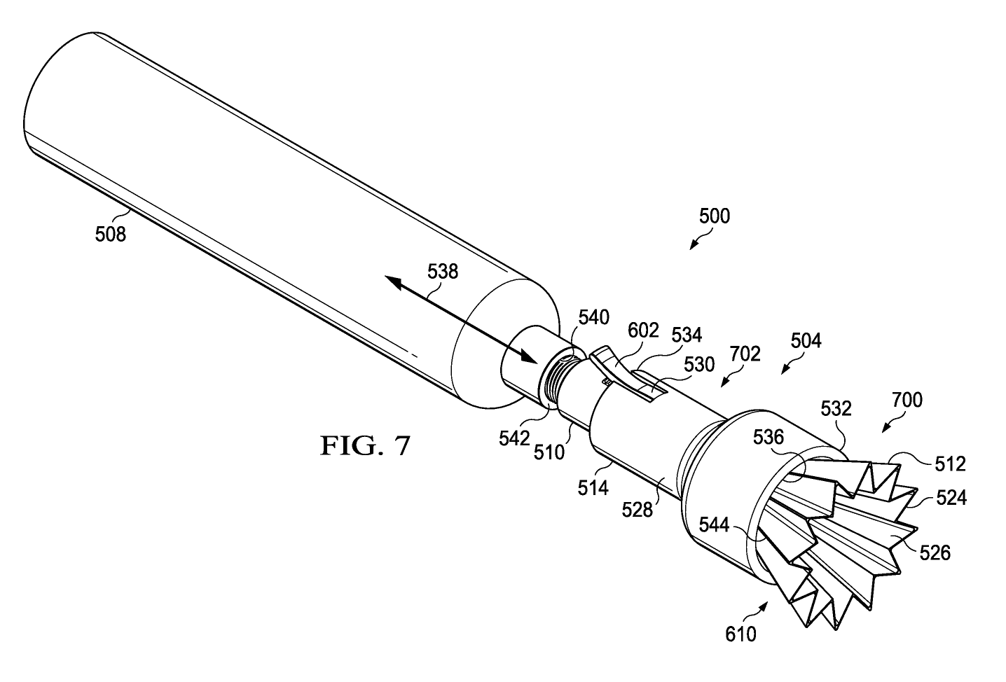

With reference now to FIG. 7, an illustration of a perspective view of a portion of a sealant application system is depicted in accordance with an advantageous embodiment. In this illustrative example, cartridge 508, applicator tool 504, and second elongate member 528 for sealant application system 500 are assembled together.

Nozzle 512 has shape 700 in this illustrative example. As depicted, positioning system 530 holds second elongate member 528 at position 702 such that nozzle 512 has shape 700.

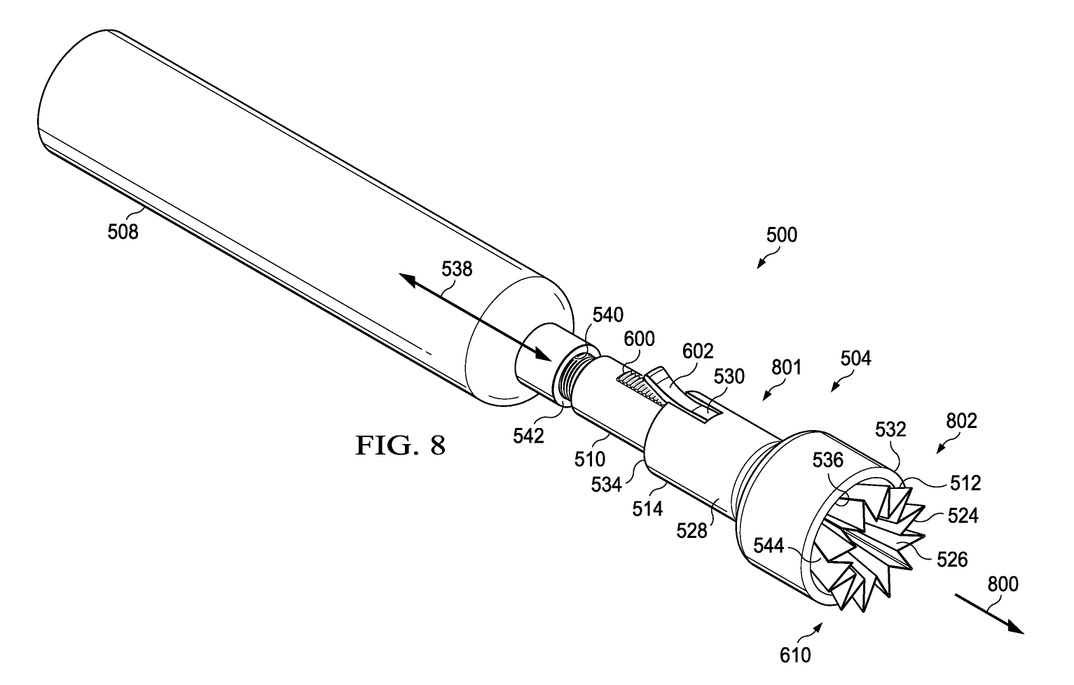

With reference now to FIG. 8, an illustration of a perspective view of a portion of a sealant application system is depicted in accordance with an advantageous embodiment. In this illustrative example, second elongate member 528 has been moved in the direction of arrow 800 to change position 702 of second elongate member 528 in FIG. 7 to position 801. Further, this movement of second elongate member 528 also changes shape 700 of nozzle 512 in FIG. 7 to shape 802.

As depicted, positioning system 530 holds second elongate member 528 at position 801 such that nozzle 512 has shape 802. With shape 802, a smaller amount of sealant may be applied through nozzle 512 as compared to with shape 700 in FIG. 7. Further, the sealant applied through nozzle 512 may have smaller dimensions with shape 802 for nozzle 512 as compared to shape 700 in FIG. 7.

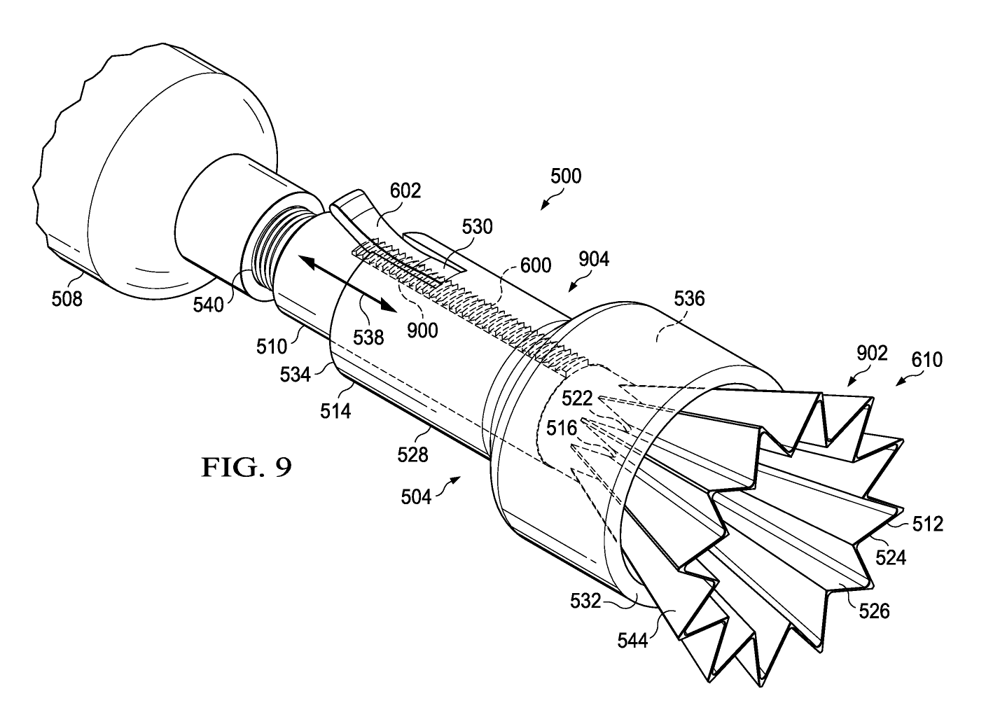

With reference now to FIG. 9, an illustration of an exposed view of a portion of a sealant application system is depicted in accordance with an advantageous embodiment. In this illustrative example, a portion of first elongate member 510 and a portion of nozzle 512 extend through third channel 536 through second elongate member 528.

As depicted, teeth 600 on first elongate member 510 engage teeth 900 inside second elongate member 528 to hold second elongate member 528 at position 904 such that nozzle 512 has shape 902.

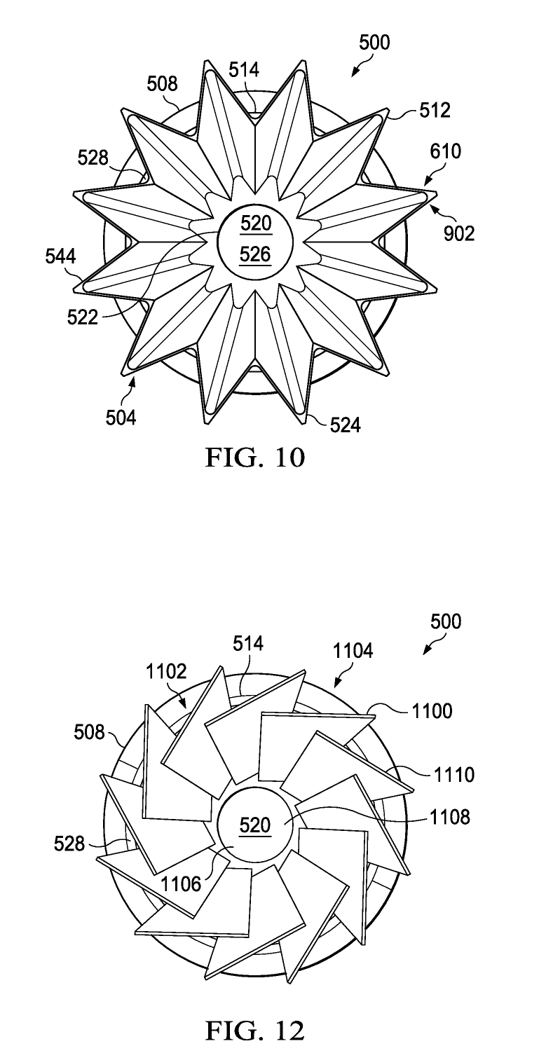

With reference now to FIG. 10, an illustration of an end view of a portion of a sealant application system is depicted in accordance with an advantageous embodiment. In this illustrative example, sealant application system 500 is seen from output 524 of nozzle 512. Further, in this depicted example, nozzle 512 has shape 902 from FIG. 9.

Sealant in cartridge 508 may be allowed to flow through cartridge 508, into first elongate member 510 in FIG. 5, through input 522 of nozzle 512, and out of output 524 of nozzle 512.

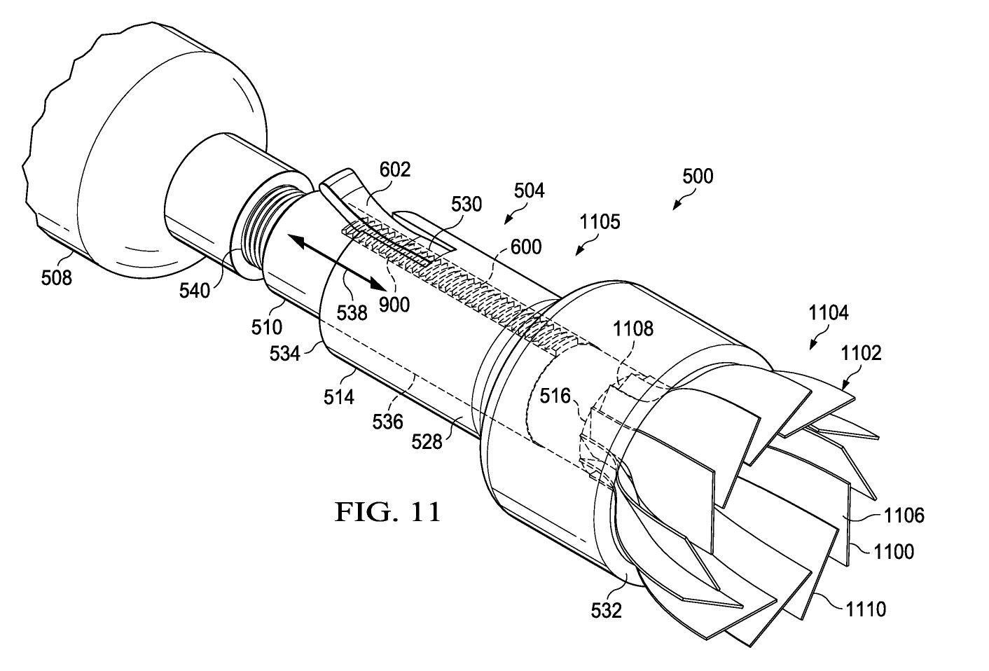

With reference now to FIG. 11, an illustration of an exposed view of a portion of a sealant application system is depicted in accordance with an advantageous embodiment. In this illustrative example, sealant application system 500 has applicator tool 504 with nozzle 1100 instead of nozzle 512 in FIGS. 5-10.

As depicted, nozzle 1100 is comprised of plurality of panels 1102 that form shape 1104 for nozzle 1100. In this depicted example, second elongate member 528 is held at position 1105 to provide shape 1104 for nozzle 1100. Plurality of panels 1102 may have different shapes and/or sizes, depending on the implementation. In this illustrative example, each of plurality of panels 1102 has a trapezoidal-type shape.

Shape 1104 may be changed by moving second elongate member 528 along axis 538. For example, when second elongate member 528 is moved in a direction towards nozzle 1100, plurality of panels 1102 moves to form a smaller shape for shape 1104 of nozzle 1100. In other words, plurality of panels 1102 is flexible and capable of moving to form a different shape for nozzle 1100. When second elongate member 528 is moved in a direction towards cartridge 508, plurality of panels 1102 is moved to form a larger shape for shape 1104.

Sealant is applied through first channel 520 (not shown) of first elongate member 510 and flows through channel 1106 extending through nozzle 1100. Channel 1106 extends from input 1108 of nozzle 1100 to output 1110 of nozzle 1100.

With reference now to FIG. 12, an illustration of an end view of a portion of a sealant application system is depicted in accordance with an advantageous embodiment. In this illustrative example, sealant application system 500 is seen from output 1110 of nozzle 1100 in FIG. 11. Further, in this depicted example, nozzle 1100 has shape 1104 in FIG. 11.

Sealant in cartridge 508 may be allowed to flow through cartridge 508, into first elongate member 510 in FIG. 5, through input 1108 of nozzle 1100, and out of output 1110 of nozzle 1100.

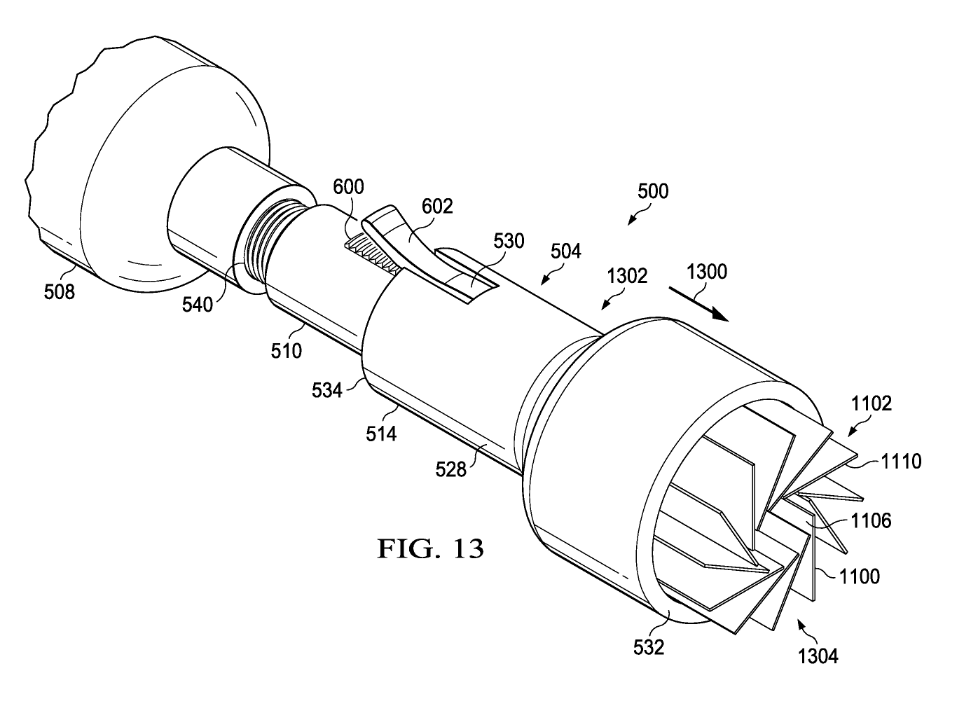

With reference now to FIG. 13, an illustration of an exposed view of a portion of a sealant application system is depicted in accordance with an advantageous embodiment. In this illustrative example, second elongate member 528 has been moved from position 1105 in FIG. 11 in the direction of arrow 1300 to position 1302.

When second elongate member 528 is moved to position 1302, plurality of panels 1102 is moved as well. At position 1302 for second elongate member 528, shape 1104 of nozzle 1100 in FIG. 11 is changed to shape 1304. Shape 1304 is a larger shape that allows a greater amount of sealant to be applied.

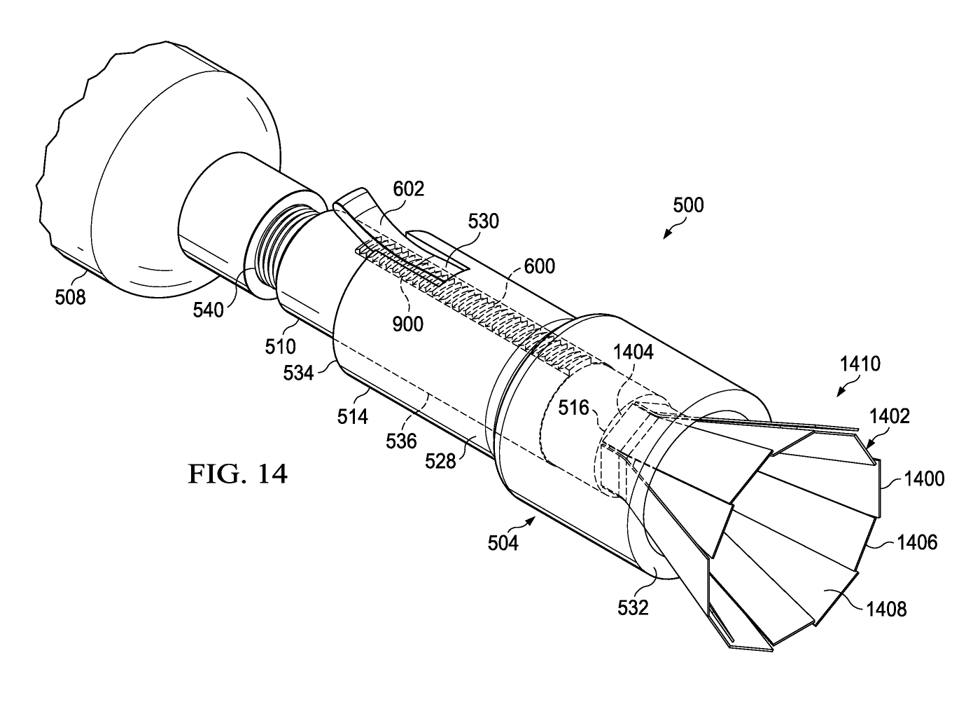

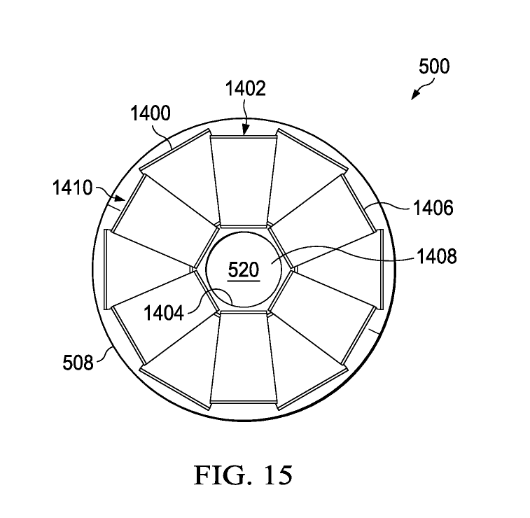

With reference now to FIG. 14, an illustration of an exposed view of a portion of a sealant application system is depicted in accordance with an advantageous embodiment. In this illustrative example, sealant application system 500 has applicator tool 504 with nozzle 1400 instead of nozzle 512 in FIG. 5 or nozzle 1100 in FIG. 11. Nozzle 1400 is comprised of plurality of panels 1402. Plurality of panels 1402 has a shape different from the shape for plurality of panels 1102 in FIG. 11.

Nozzle 1400 has input 1404 and output 1406 with channel 1408 extending from input 1404 to output 1406. In this illustrative example, nozzle 1400 has shape 1410.

With reference now to FIG. 15, an illustration of an end view of a portion of a sealant application system is depicted in accordance with an advantageous embodiment. In this illustrative example, sealant application system 500 is seen from output 1406 of nozzle 1400 in FIG. 14. Further, in this depicted example, nozzle 1400 has shape 1410 in FIG. 14.

Sealant in cartridge 508 may be allowed to flow through cartridge 508, into first elongate member 510 in FIG. 5, through input 1404 of nozzle 1400, and out of output 1406 of nozzle 1400.

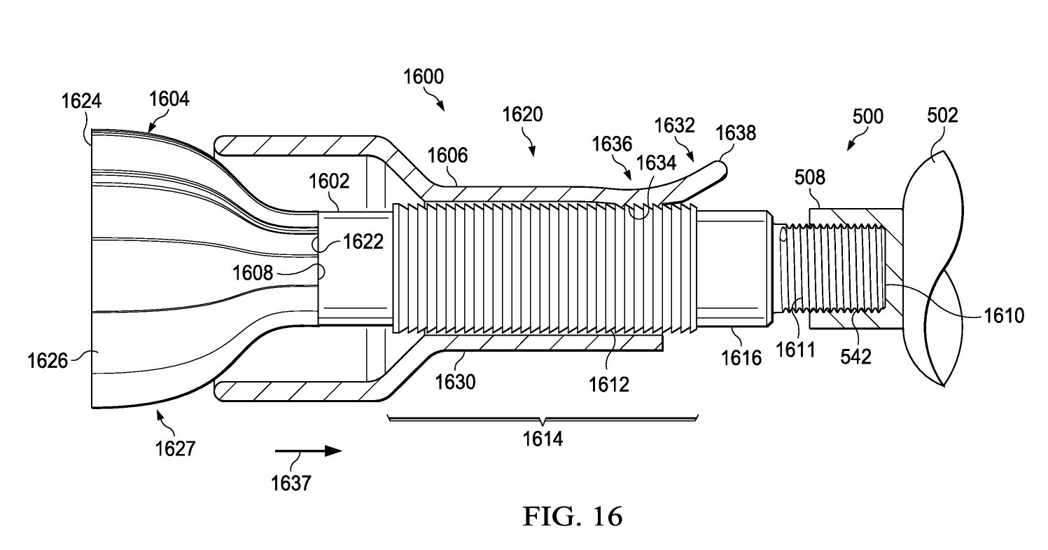

With reference now to FIG. 16, an illustration of an exposed view of a portion of a sealant application system is depicted in accordance with an advantageous embodiment. In this illustrative example, sealant application system 500 has a different applicator tool as compared to sealant application system 500 in FIGS. 5-15.

As depicted, sealant application system 500 has applicator tool 1600. Applicator tool 1600 comprises first elongate member 1602, nozzle 1604, and biasing system 1606. First elongate member 1602 has first end 1608 and second end 1610. Further, first elongate member 1602 has a first channel (not shown in this view) extending from first end 1608 to second end 1610.

In this depicted example, threads 1611 at second end 1610 of first elongate member 1602 engage threads 542 in cartridge 508. Sealant may flow from cartridge 508 through the first channel in first elongate member 1602.

In this illustrative example, first elongate member 1602 has teeth 1612 that extend all the way around portion 1614 on outer surface 1616 of first elongate member 1602. Teeth 1612 on portion 1614 of first elongate member 1602 form ratchet 1620 in this depicted example.

As depicted, nozzle 1604 has input 1622 and output 1624. Input 1622 is connected to first end 1608 of first elongate member 1602. A second channel (not shown in this view) extends from input 1622 to output 1624. Sealant flowing through the first channel in first elongate member 1602 flows through the second channel in nozzle 1604.

Nozzle 1604 is comprised of plurality of panels 1626 that has a flexibility that allows the shape of nozzle 1604 to be changed. In this illustrative example, plurality of panels 1626 has a curved shape that is different than the shape of plurality of panels 1102 in FIG. 11. Plurality of panels 1626 provides shape 1627 for nozzle 1604.

In this illustrative example, biasing system 1606 includes second elongate member 1630 and positioning system 1632. Second elongate member 1630 holds at least a portion of first elongate member 1602 and nozzle 1604. Second elongate member 1630 has teeth 1634 that form pawl 1636 in this illustrative example. Teeth 1634 engage teeth 1612 on outer surface 1616 of first elongate member 1602. When teeth 1634 and teeth 1612 are engaged, biasing system 1606 may not be capable of moving in the direction of arrow 1637.

Lever 1638 for positioning system 1632 is used to disengage teeth 1634 from teeth 1612 to allow biasing system 1606 to be moved in the direction of arrow 1637. For example, lever 1638 may be moved in the direction of arrow 1637. This movement of lever 1638 allows biasing system 1606 to move in the direction of arrow 1637.

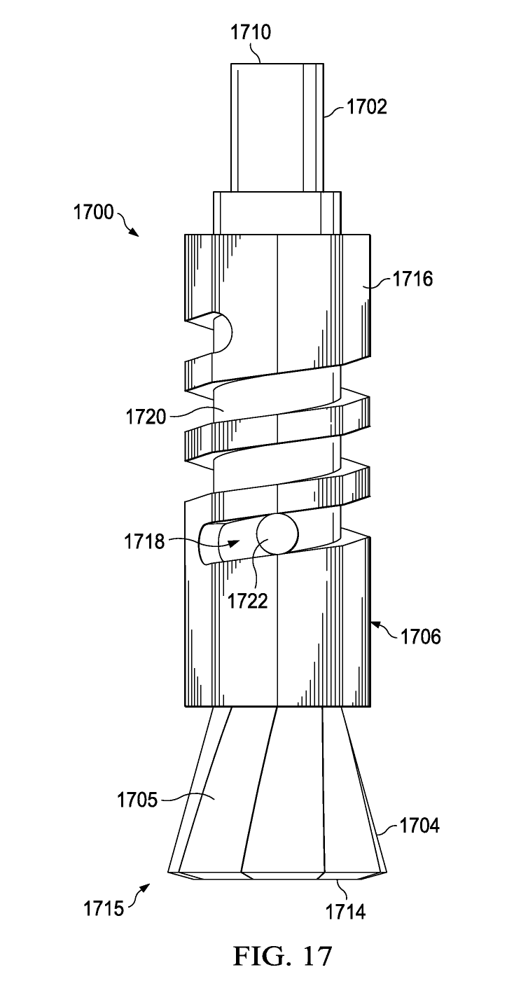

With reference now to FIG. 17, an illustration of an applicator tool is depicted in accordance with an advantageous embodiment. In this illustrative example, applicator tool 1700 is an example of one implementation for applicator tool 320 in FIGS. 3 and 4.

As depicted, applicator tool 1700 includes first elongate member 1702, nozzle 1704, and biasing system 1706. First elongate member 1702 has a first end (not shown in the view) and second end 1710. Second end 1710 is configured to be connected to a sealant source, such as sealant source 318 in FIG. 3 and/or sealant source 502 in FIG. 5. As one specific example, second end 1710 may be connected to cartridge 508 for sealant source 502 in FIG. 5.

Further, the first end of first elongate member 1702 is connected to nozzle 1704. Nozzle 1704 takes the form of plurality of panels 1705 in this illustrative example. Further, nozzle 1704 has shape 1715. Nozzle 1704 has flexibility such that shape 1715 for nozzle 1704 may be changed. Nozzle 1704 has an input (not shown in this view) and output 1714.

In this illustrative example, biasing system 1706 includes second elongate member 1716 and positioning system 1718. Second elongate member 1716 covers at least a portion of first elongate member 1702 and nozzle 1704.

As depicted in this example, positioning system 1718 is comprised of channel 1720 in second elongate member 1716 and post 1722 on first elongate member 1702. Second elongate member 1716 and first elongate member 1702 may be rotated relative to each other to move second elongate member 1716. For example, the rotation of second elongate member 1716 and first elongate member 1702 relative to each other causes post 1722 to be moved with respect to channel 1720.

One or both of first elongate member 1702 and second elongate member 1716 may be rotated. This rotation may be performed using a motor or some other suitable device. In some illustrative examples, an operator may rotate one or both of first elongate member 1702 and second elongate member 1716 relative to each other. Movement of second elongate member 1716 causes shape 1715 of nozzle 1704 to be changed.

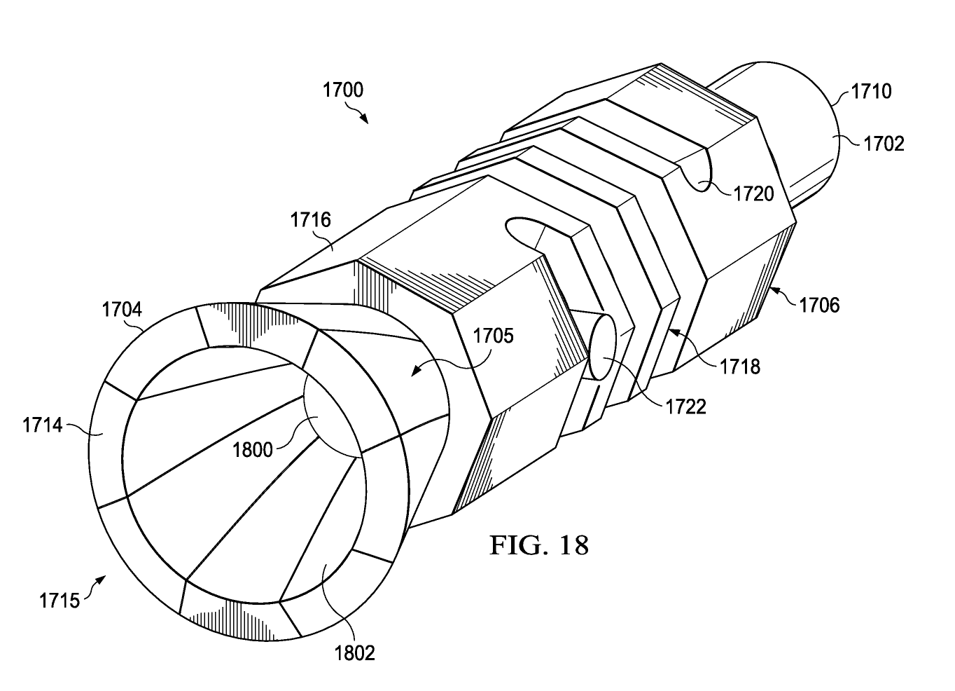

With reference now to FIG. 18, an illustration of a perspective view of an applicator tool is depicted in accordance with an advantageous embodiment. In this illustrative example, a perspective view of applicator tool 1700 in FIG. 17 is depicted. As depicted, nozzle 1704 has input 1800 and output 1714. Channel 1802 extends from input 1800 to output 1714.

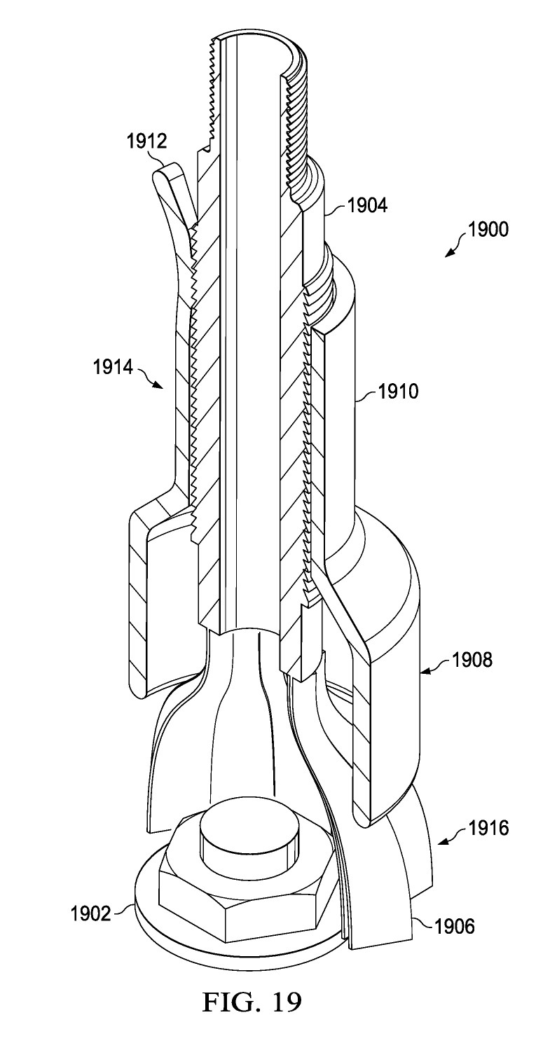

With reference now to FIG. 19, an illustration of a cross-sectional perspective view of an applicator tool over a fastener is depicted in accordance with an advantageous embodiment. In this illustrative example, applicator tool 1900 is an example of one implementation for applicator tool 320 in FIGS. 3 and 4. As depicted, applicator tool 1900 is positioned over fastener 1902.

In this illustrative example, applicator tool 1900 includes first elongate member 1904, nozzle 1906, and biasing system 1908. Biasing system 1908 includes second elongate member 1910 and positioning system 1912. Positioning system 1912 holds second elongate member 1910 in position 1914 such that nozzle 1906 has shape 1916. Shape 1916 is a shape that allows sealant to be applied onto fastener 1902 in the desired amount and/or having the desired dimensions.

Positioning system 1912 allows second elongate member 1910 to be moved to change shape 1916 for nozzle 1906 for applying sealant to a different fastener having different requirements for the application of the sealant.

The illustrations of sealant application system 500 in FIGS. 5-16, applicator tool 1700 in FIGS. 17-18, and applicator tool 1900 in FIG. 19 are not meant to imply physical or architectural limitations to the manner in which the different advantageous embodiments may be implemented.

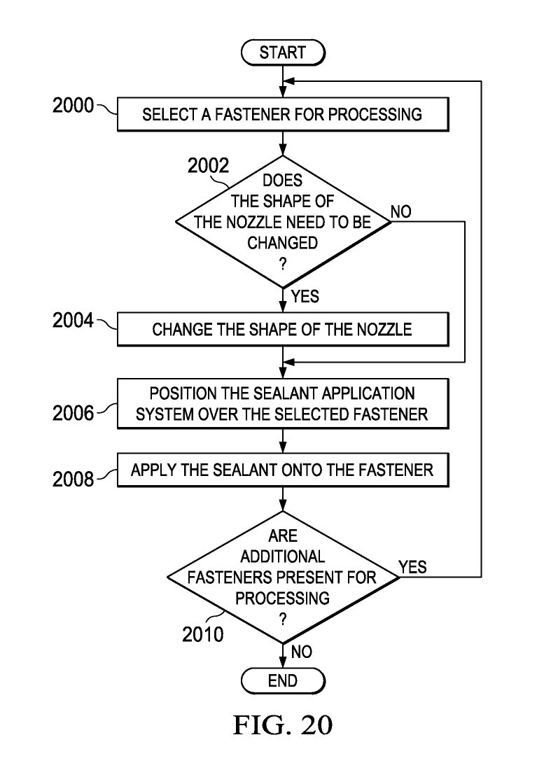

With reference now to FIG. 20, an illustration of a flowchart of a process for applying sealant is depicted in accordance with an advantageous embodiment. The process illustrated in FIG. 20 may be implemented using sealant application system 302 in FIG. 3. In particular, the process may be implemented using sealant application system 500 in FIG. 5, sealant application system 500 in FIG. 11, sealant application system 500 in FIG. 14, sealant application system 500 in FIG. 16, or some other suitable sealant application system.

The process begins by selecting a fastener for processing (operation 2000). The selected fastener is one on which sealant is to be applied. The fastener may be, for example, without limitation, a rivet, a bolt, a nut, a screw, or some other suitable type of fastener. The sealant may be applied to the fastener using a sealant application system. The sealant application system may be implemented using, for example, sealant application system 302 in FIG. 3 and/or one of the configurations for sealant application system 500 in FIGS. 5-16.

The process then determines whether the shape of the nozzle needs to be changed (operation 2002). The shape of the nozzle determines the amount, dimensions, and/or other suitable characteristics of the sealant being applied to the selected fastener. The shape of the nozzle may need to be changed based on the type of fastener, the size of the fastener, specifications and/or requirements for the application of the sealant, and/or other suitable factors.

If the shape of the nozzle needs to be changed, the process changes the shape of the nozzle (operation 2004). In operation 2004, the shape of the nozzle may be changed by moving the second elongate member along an axis common to the first elongate member, the nozzle, and the biasing system. The shape of the nozzle is changed to a desired shape to apply the sealant in the desired amount and having the desired dimensions.

Thereafter, the process positions the sealant application system over the selected fastener (operation 2006). Next, the process applies the sealant onto the fastener (operation 2008). The process then determines whether additional fasteners are present for processing (operation 2010). If additional fasteners are not present for processing, the process terminates. Otherwise, the process returns to operation 2000 as described above.

With reference again to operation 2002, if the shape of the nozzle does not need to be changed, the process proceeds to operation 2006, as described above. In this manner, sealant may be applied onto a number of fasteners in the desired amount and having the desired dimensions.

The flowchart and block diagrams in the different depicted embodiments illustrate the architecture, functionality, and operation of some possible implementations of apparatus and methods in different advantageous embodiments. In this regard, each block in the flowchart or block diagrams may represent a module, segment, function, and/or a portion of an operation or step. In some alternative implementations, the function or functions noted in the block may occur out of the order noted in the figures. For example, in some cases, two blocks shown in succession may be executed substantially concurrently, or the blocks may sometimes be executed in the reverse order, depending upon the functionality involved. Also, other blocks may be added in addition to the illustrated blocks in a flowchart or block diagram.

Thus, the different advantageous embodiments provide a method and apparatus for applying a sealant to a structure. In one advantageous embodiment, the apparatus comprises a first elongate member having a first end, a second end, and a channel extending through from the first end to the second end. A nozzle is present having an input and an output. The input of the nozzle is associated with the first end of the first elongate member. A second channel extends through the nozzle from the input of the nozzle to the output of the nozzle. The first channel is in communication with the second channel. The apparatus also includes a biasing system. The biasing system is configured to engage an outer surface of the nozzle. The biasing system is configured to move on the outer surface of the nozzle such that the shape of the second channel changes.

The description of the different advantageous embodiments has been presented for purposes of illustration and description and is not intended to be exhaustive or limited to the embodiments in the form disclosed. Many modifications and variations will be apparent to those of ordinary skill in the art. Further, different advantageous embodiments may provide different advantages as compared to other advantageous embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. An apparatus comprising:
an elongate member having a first end and a second end;
a first channel extending through the elongate member from the first end of the elongate member to the second end of the elongate member;
a nozzle having an input and an output, wherein the input of the nozzle is associated with the first end of the elongate member;
a second channel extending through the nozzle from the input of the nozzle to the output of the nozzle, wherein the first channel is in communication with the second channel; and
a biasing system configured to engage an outer surface of the nozzle, wherein the biasing system is configured to move on the outer surface of the nozzle such that the second channel changes shape.

2. The apparatus of claim 1, wherein the elongate member is a first elongate member and wherein the biasing system comprises:
a second elongate member having a first end and a second end;
a third channel extending through the second elongate member from the first end of the second elongate member to the second end of the second elongate member, wherein the third channel is configured to receive at least a portion of the first elongate member and at least a portion of the nozzle, wherein the first end of the second elongate member is configured to engage the outer surface of the nozzle, and wherein movement of the first end of the second elongate member on the outer surface of the nozzle and along an axis through the nozzle causes the second channel to change shape.

3. The apparatus of claim 2, wherein the biasing system further comprises:
a positioning system configured to position the second elongate member along the axis.

4. The apparatus of claim 3, wherein the positioning system comprises:
a first plurality of teeth associated with a wall in the third channel of the second elongate member; and
a second plurality of teeth associated with a surface on the first elongate member, wherein the first plurality of teeth is configured to engage the second plurality of teeth such that the second elongate member is held in a position relative to the first elongate member and to guide the movement of the second elongate member relative to the first elongate member along the axis.

5. The apparatus of claim 3, wherein the positioning system comprises:
an engagement member on a surface of the first elongate member;
a channel in the second elongate member, wherein the engagement member engages the channel and is configured to hold the second elongate member in a position relative to the first elongate member and to guide the movement of the second elongate member relative to the first elongate member along the axis.

6. The apparatus of claim 1, wherein the nozzle comprises:
a one-piece shell having a flexibility that is configured to change shape in response to movement of the biasing system on the outer surface of the nozzle such that the second channel changes shape.

7. The apparatus of claim 1, wherein the nozzle comprises:
a plurality of panels configured in a shape for the nozzle, wherein the plurality of panels has a flexibility that is configured to allow the second channel to change shape.

8. The apparatus of claim 7, wherein the biasing system is configured to change the shape of the nozzle.

9. The apparatus of claim 1, wherein the elongate member is a cylinder.

10. The apparatus of claim 5, wherein the engagement member is a post on the surface of the first elongate member.

11. The apparatus of claim 1 further comprising:
a sealant source, wherein the second end of the elongate member is configured for attachment to the sealant source.

12. The apparatus of claim 11, wherein the sealant source has a housing and a cartridge located in the housing, wherein the cartridge contains a sealant, and wherein the cartridge is connected to the second end of the first elongate member such that the sealant is allowed to flow through the first channel for the first elongate member.

13. A sealant application system for applying a sealant comprising:
a first elongate member having a first end, a second end, and a first channel extending through the first elongate member from the first end of the first elongate member to the second end of the first elongate member;
a nozzle having an input associated with the first end of the first elongate member, an output, and a second channel extending through the nozzle from the input of the nozzle to the output of the nozzle in which the first channel is in communication with the second channel;
a second elongate member having a first end, a second end, and a third channel extending through the second elongate member from the first end of the second elongate member to the second end of the second elongate member, wherein the third channel is configured to receive at least a portion of the first elongate member and at least a portion of the nozzle, and wherein the first end of the second elongate member is configured to engage an outer surface of the nozzle;
a positioning system configured to guide movement of the second elongate member on the outer surface of the nozzle relative to the first elongate member along an axis through the nozzle, wherein the movement of the second elongate member on the outer surface of the nozzle causes the second channel to change shape.

14. The sealant application system of claim 13, wherein the first elongate member, the nozzle, the second elongate member, and the positioning system form an applicator tool and further comprising:
a sealant source having a housing and a cartridge located in the housing, wherein the cartridge contains the sealant and wherein the applicator tool is connected to the sealant source.

15. The sealant application system of claim 13, wherein the positioning system comprises:
a first plurality of teeth associated with a wall in the third channel of the second elongate member; and
a second plurality of teeth associated with a surface on the first elongate member, wherein the first plurality of teeth engage the second plurality of teeth such that the second elongate member is held in a position relative to the first elongate member.

16. The sealant application system of claim 13, wherein the positioning system comprises:
an engagement member on a surface of the first elongate member;
a channel in the second elongate member, wherein the engagement member engages the channel and is configured to hold the second elongate member in a position relative to the first elongate member.

17. The sealant application system of claim 13, wherein the nozzle comprises:
a one-piece shell having a flexibility that is configured to change shape in response to the movement of the second elongate member on the outer surface of the nozzle such that the second channel changes shape.

18. The sealant application system of claim 13, wherein the nozzle comprises:
a plurality of panels configured in a shape for the nozzle, wherein the plurality of panels has a flexibility that is configured to allow the second channel to change shape.

19. A method for applying a sealant, the method comprising:
positioning a sealant application system over a fastener, wherein the sealant application system comprises an elongate member having a first end and a second end, wherein the first end is connected to a sealant source for the sealant; a first channel extending through the elongate member from the first end of the elongate member to the second end of the elongate member; a nozzle having an input and an output, wherein the input of the nozzle is associated with the first end of the elongate member; a second channel extending through the nozzle from the input of the nozzle to the output of the nozzle, wherein the first channel is in communication with the second channel; and a biasing system configured to engage an outer surface of the nozzle, wherein the biasing system is configured to move on the outer surface of the nozzle such that the second channel changes shape; and
applying the sealant onto the fastener.

20. The method of claim 19 further comprising:
determining whether a shape of the nozzle needs to be changed; and
responsive to a determination that the shape of the nozzle needs to be changed, changing the shape of the nozzle by moving the biasing system on the outer surface of the nozzle such that the second channel changes shape.
